(19) United States
(12) Patent Application Publication
(10) Pub. No.: US 2011/0180480 A1
(43) Pub. Date: Jul. 28, 2011

(54) REVERSE-OSMOSIS SYSTEM WITH AN APPARATUS FOR REDUCING NOISE AND METHOD FOR REDUCING NOISE IN A REVERSE-OSMOSIS SYSTEM

(76) Inventors: Peter Kloeffel, Nuedlingen (DE); Olaf Nicholas, Kitzingen (DE); Reiner Spickermann, Burghausen (DE)

(21) Appl. No.: 12/737,755

(22) PCT Filed: Aug. 12, 2009
(86) PCT No.: PCT/EP2009/005857

§ 371 Date: Mar. 22, 2011

(30) Foreign Application Priority Data
Aug. 12, 2008 (DE) 10 2008 038 751.7

(51) Int. Cl. B01D 61/10; C02F 1/44; B01D 61/30

(52) U.S. Cl. 210/652; 210/143

(57) ABSTRACT

The present invention relates to a reverse osmosis system having an apparatus for noise cancellation of the reverse osmosis system, wherein the apparatus has at least one sensor for the detection of at least one noise emitted by the reverse osmosis system; at least one controller connected to the sensor for the evaluation of the signal or signals obtained from the sensor; and at least one actuator connected to the controller, with the actuator being designed such that it generates an acoustic signal or a vibration by means of which the noise emitted by the reverse osmosis system is damped or cancelled out.

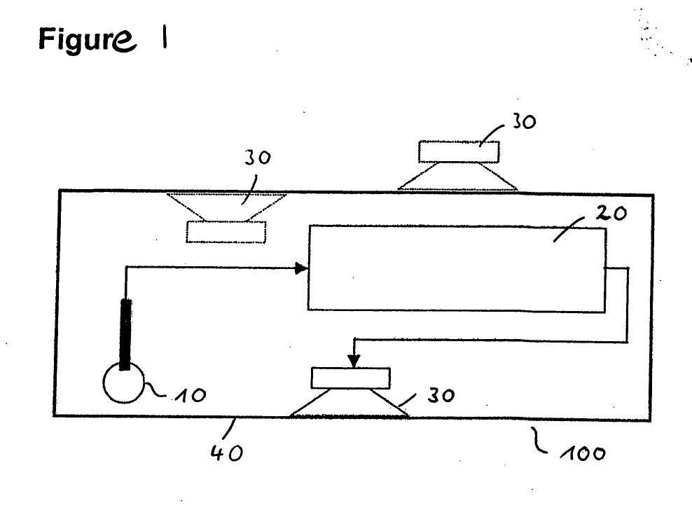

The present invention relates to a reverse osmosis system having an apparatus for noise cancelling of the reverse osmosis system.

A reverse osmosis water treatment unit (RO unit), in the following briefly a reverse osmosis system, of a dialysis machine with integrated water treatment represents a substantial source of noise. It is already known from the prior art to carry out a reduction in the noise emissions. U.S. Pat. No. 4,498,982 thus discloses, for example, a reduction of the noise emissions of a reverse osmosis system by an unvented enclosure. A certain noise reduction can admittedly be achieved using the measure proposed in U.S. Pat. No. 4,498,982; however, there is still a desire to reduce the noise emissions further. This applies, for example, to dialysis centers or in clinics, but also to home dialysis, that is, with dialysis machines used in the personal sector. They should also be able to be operated as quietly as possible to reduce the noise strains on the patients and to improve the treatment comfort. The present invention not only covers dialysis machines with an integrated water treatment, but also both internal and external RO systems for water preparation in connection with dialysis.

This object is satisfied by a reverse osmosis system having the features of claim 1.

Provision is accordingly made for the apparatus for noise cancelling to have at least one sensor for the detection of at least one noise emitted by the reverse osmosis system; at least one controller connected to the sensor for the evaluation of the signal or signals obtained from the sensor; as well as at least one actuator connected to the controller, wherein the actuator is made such that it generates such an acoustic signal or such a vibration that the noise generated by the reverse osmosis system is damped or cancelled out.

The present invention is thus based on the idea of “active noise cancelling” (ANC). Such active noise cancelling is known, for example, on computers (U.S. Pat. No. 5,636,286) and also in the field of medical engineering. Reference is made by way of example to U.S. Pat. No. 5,427,102 and to U.S. Pat. No. 5,13,945 which relate to the active noise cancellation of an MRI unit or to U.S. Pat. No. 4,672,977 which has the elimination of the sounds of the lung as its subject for the purpose of detecting heart signals.

The use of this technology in the field of noise cancellation in reverse osmosis systems in general, and in particular in the area of dialysis, is new, however. The desire for the use of hemodialysis, in particular for home dialysis, makes an ideal noise cancellation at the site of generation particularly desirable, whereby the higher apparatus effort associated with ANC is justified.

The noise reduction in accordance with the invention not only covers classical ANC in which the actuator represents an acoustic source (loudspeaker) which generates an opposed acoustic signal which reduces or cancels out the acoustic disturbance arising from one or more components of the reverse osmosis system. The so-called “active structural acoustic control” (ASAC) is also covered by the present invention. This covers construction measures which attenuate vibrations and noises actively by mechanical oscillations. Vibration sources such as so-called shakers or also piezoceramics are used as actuators here which counteract the vibration behavior of an arrangement and reduce or fully eliminate the noise emissions in this manner.

The object of the actuator for the generation of the counter-noise or counter-directed vibrations comprises attenuating or cancelling out, where possible, the noise generation at the noise source or sources themselves, where possible, or at coupled components.

Provision is made in a preferred embodiment of the invention for the reverse osmosis system to have a house wall and for the at least one actuator to be arranged at the outer side and/or at the inner side of the housing wall. The actuators, such as shakers, for the generation of the counter-noise or opposed vibrations can thus be attached to one or more points of the housing wall of the reverse osmosis system, and indeed inside the housing and/or also outside the housing. The actuator or actuators can e.g. be arranged centrally and/or also in the marginal region of the housing wall.

It is conceivable for the actuator or actuators to directly contact the housing wall.

The technology in accordance with the invention for the noise cancellation can generally also attenuate the noise emissions of other noise sources of a dialysis machine. Such other possible noise sources are e.g. the pumps of a dialysis machine.

Provision is made in a further embodiment of the invention for the reverse osmosis system to have a support structure and for the at least one actuator to be arranged directly or indirectly at the support structure.

Provision can furthermore be made for the at least one actuator to be arranged directly at or in one of the components of the reverse osmosis system or to be arranged at or in the reverse osmosis system by means of a support element. It is, for example, conceivable for the component to be the pump of the reverse osmosis system. It would be conceivable in this respect for the at least one actuator to be arranged directly at the pump, for example, at the pump head of the pump or at the pump motor.

It is equally conceivable to arrange the actuator at a holding bracket or at any other support structure, with the positioning preferably taking place such that a noise attenuation or elimination takes place which is as large as possible.

It is, for example, conceivable to arrange the actuator, which can as stated above be made as a shaker, for example, at a support bracket lengthways to the pump motor or also transversely to the pump motor.

As stated above, provision can alternatively or additionally be made to attach the actuator or actuators to the housing wall.

The present invention furthermore relates to a dialysis machine which is connected to a dialysis machine in accordance with one of the claims 1 to 8 or which has such a reverse osmosis system.

It is conceivable that it is a dialysis machine having an integrated water treatment unit in the form of a reverse osmosis system. As stated above, a conceivable use of such dialysis machines is the sector of home dialysis. The invention is, however, not restricted to this, but rather likewise includes dialysis machines which are usually used in dialysis centers or in clinics, since there is also a need there to be able to operate dialysis machines as quietly as possible to reduce the noise strain on the patients and to improve the treatment comfort.

Provision is made in a further embodiment of the invention for the controller of the apparatus for noise cancellation to be a component of a processing unit or control unit of the dialysis machine or to be connected to the processing unit or control unit of the dialysis machine. Modern dialysis machines usually have a plurality of microprocessors with a considerable computing power which will be further expanded in future generations of dialysis machines. An additional synergetic effect results here for the use of the apparatus for noise attenuation since the apparatus requires computing power. This computing power is required to process the signal recorded by means of the sensor or sensors and to emit signals based thereon to the actuator or actuators such that they generate a counter-noise or vibrations which serve the noise cancellation or elimination.

One aspect of the present invention thus comprises the controller either being a component of the processing unit or control unit of the dialysis machine or being connected thereto such that certain computing power is taken over by the processing unit or control unit of the dialysis machine.

The present invention furthermore relates to a method for noise cancellation of a reverse osmosis system having the features of claim 11. Provision is accordingly made for at least a noise emitted by the reverse osmosis system to be detected, for the detected noise to be evaluated and for an acoustic signal or a vibration to be generated in dependence on the evaluation made by means of which signal or vibration the noise generated on the side of the reverse osmosis system is damped or cancelled out.

As already stated above, provision can be made for noises to be detected at a plurality of positions of the reverse osmosis system and/or for acoustic signals and/or vibrations to be generated at a plurality of positions of the reverse osmosis system by means of which acoustic signal and/or vibrations the detected noise is damped or cancelled out. As likewise stated, the evaluation of the detected noise can be carried out or at least supported by a processing unit or control unit of the dialysis machine

Further details and advantages of the invention will be explained with reference to an embodiment shown in the drawing. The only FIGURE shows a reverse osmosis system in accordance with the present invention in a schematic view.

The reverse osmosis system 100 in accordance with the FIGURE has a sensor 10 which is made as a microphone and which records the noises of the reverse osmosis system at a suitable position. It is, for example, conceivable to arrange the microphone at or in the region of the intake hose of the pump of the reverse osmosis system. The signal or signals representing the noise or noises is/are transferred to a controller 20. The latter processes the recorded signals, optionally by support from the processing unit and control unit of a dialysis machine, and determines output signals which are then transmitted to at least one actuator 30. In this respect, the output signals are determined such that the acoustic signals or vibrations generated by the actuator 30 counteract the noises recorded by the sensors 10 as much as possible.

In the example shown here, the controller 20 is a component of the reverse osmosis system 100. It is generally likewise conceivable to arrange the controller in the dialysis machine such that the evaluation takes place there and the signals are then transmitted from there to the actuator or actuators 30.

The actuator 30 can be made as an acoustic source, that is, as a loudspeaker, which generates a noise or sound which is opposed to the noise recorded and which cancels out or attenuates the disturbance.

Provision can alternatively or additionally be made for the actuator to generate vibrations which counteract the vibration behavior of the arrangement in question such as the total reverse osmosis system or a component thereof such as the pump or the pump motor. The vibration source can, for example, be made as a so-called shaker or as piezoceramics. Other vibrations sources are also conceivable which generate an opposite vibration in a suitable manner.

In the embodiment shown in the FIGURE, the actuator 30 is located on the inner side of the housing wall 40 of the reverse osmosis system 100.

Alternatively or additionally to this, one or more actuators 30 can be arranged on the outer side of the housing wall 40 or also at another position of the inner wall of the housing. These further or alternative positions of actuators are indicated by dotted lines in the FIGURE.

It is conceivable to feed the signal of the sensor 10 or of the microphone via a separate input amplifier into a frequency switch or into an equalizer. It is furthermore conceivable for the output signal of the controller to be transferred via a further amplifier to the bass shaker or bass shakers. As stated above, in the embodiment shown here, it is the object of the bass shakers or actuators 30 to compensate the sound generation at the source itself or also at connected components by means of active negative feedback.

1. A reverse osmosis system (100) having an apparatus for noise cancellation of the reverse osmosis system (100), characterized in that the apparatus has at least one sensor (10) for the detection of at least one noise emitted by the reverse osmosis system (100); at least one controller (20) connected to the sensor (10) for the evaluation of the signal or signals obtained from the sensor (10); and at least one actuator (30) connected to the controller (20), with the actuator (30) being designed such that it generates an acoustic signal or a vibration by means of which the noise emitted by the reverse osmosis system (100) is damped or cancelled out.

2. A reverse osmosis system (100) in accordance with claim 1, characterized in that the actuator (30) is made as a loudspeaker.

3. A reverse osmosis system (100) in accordance with claim 1, characterized in that the actuator (30) is made as a vibration source.

4. A reverse osmosis system (100) in accordance with claim 1, characterized in that the reverse osmosis system (100) has a housing wall (40); and in that the at least one actuator (30) is arranged at the outer side and/or at the inner side of the housing wall (40).

5. A reverse osmosis system in accordance with claim 4, characterized in that the at least one actuator (30) directly contacts the housing wall (40).

6. A reverse osmosis system (100) in accordance with claim 4, characterized in that sensors (10) and/or actuators (30) are arranged at a plurality of positions of the housing wall (40) of the reverse osmosis system (100).

7. A reverse osmosis system (100) in accordance with claim 1, characterized in that the reverse osmosis system (100) has a support structure; and in that the at least one actuator (30) is arranged at the support structure.

8. A reverse osmosis system (100) in accordance with claim 1, characterized in that the at least one actuator (30) is arranged indirectly or directly at or in one of the components of the reverse osmosis system (100) or is arranged at or in the reverse osmosis system (100) by means of a support element.

9. A dialysis machine, characterized in that the dialysis machine is connected to a reverse osmosis system in accordance with claim 1 or has a reverse osmosis system in accordance with claim 1.

10. A dialysis machine in accordance with claim 9, characterized in that the controller (20) of the apparatus for noise cancellation is a component of a processing unit or control unit of the dialysis machine or is connected to the processing unit or control unit of the dialysis machine.

11. A method for noise cancellation of a reverse osmosis system (100), characterized in that at least one noise emitted by the reverse osmosis system (100) is detected in that the detected noise is evaluated; and in that an acoustic signal or a vibration is generated in dependence on the evaluation made by means of which signal or vibration the noise emitted by the reverse osmosis system (100) is damped or cancelled out.

12. A method in accordance with claim 11, characterized in that noises of the reverse osmosis system (100) are detected at a plurality of positions of the reverse osmosis system (100); and/or in that acoustic signals and/or vibrations are generated at a plurality of positions of the reverse osmosis system (100) by means of which signals or vibrations the noise emitted by the reverse osmosis system (100) is damped or cancelled out.

13. A method in accordance with claim 11, characterized in that the evaluation of the detected noise is carried out or supported by a processing unit or control unit of a dialysis machine.
